(19) United States
(12) Patent Application Publication
(10) Pub. No.: US 2024/0383480 A1
(43) Pub. Date: Nov. 21, 2024

(54) Method for Maneuvering a Vehicle on a Multi-Lane Road While Taking into Account a Gradient in a Region of an Exit of the Road, Driver Assistance System, and Vehicle

(71) Applicant: BAYERISCHE MOTOREN WERKE AKTIENGESELLSCHAFT, München (DE)

(72) Inventors: Sami FAYAD, München (DE); Stephan NIERMANN, Hebertshausen (DE); Dominik RIETH, München (DE)

(21) Appl. No.: 18/694,507

(22) PCT Filed: Sep. 1, 2022
(86) PCT No.: PCT/EP2022/074333

§ 371 Date: Mar. 22, 2024

(30) Foreign Application Priority Data
Oct. 4, 2021 (DE) 10 2021 125 693.3

(51) Int. Cl. B60W 30/18; B60W 30/14

(52) U.S. Cl. CPC B60W 30/18163; B60W 30/146; B60W 2554/4023; B60W 2720/10

(57) ABSTRACT

A method for maneuvering a vehicle on a multi-lane road has the steps of: receiving a driving command for maneuvering the vehicle from a first traffic lane of the road via a second traffic lane of the road to an exit of the road; preparing a lane change maneuver from the first traffic lane to the second traffic lane, a speed of the vehicle being adapted for the preparation of the lane change maneuver; determining a gradient of the road in a region of the exit; and adapting the preparation of the lane change maneuver in a manner which is dependent on the determined gradient.

### BACKGROUND AND SUMMARY

The present invention relates to a method for maneuvering a vehicle on a multi-lane road. Moreover, the present invention relates to a driver assistance system. Finally, the present invention relates to a vehicle with a driver assistance system of this type.

Driver assistance systems for carrying out (partially) automated lane changes or lane change assistance systems are known from the prior art. In the case of these driver assistance systems with an automated or automatic lane change function, the driver typically specifies a lane change by way of a defined operating action. If an operating action of this type is detected, the vehicle is maneuvered by means of the driver assistance system along a planned trajectory into the adjacent lane or the neighboring lane with automatic lateral control and generally also with automatic longitudinal control. In the case of driver assistance systems of this type, the driver-side lane change request is usually signaled by way of the actuation of a corresponding operating element, for example an indicator lever, in order to activate driving direction indicators which are visible from outside the vehicle.

Known driver assistance systems or lane change assistance systems generally monitor the environment of the vehicle, in particular the surrounding traffic, by way of a suitable environmental sensor system before the lane change. Upon the operating action of the driver, the lane can then be changed if a free gap for this vehicle has been detected on the adjacent lane or the target lane.

Moreover, driver assistance systems are known from the prior art, which assist a driver or user of a vehicle on a multi-lane road to reach an exit. Here, for example as a consequence of an input of a navigation destination, the driver assistance system can prepare all the necessary lane changes until the exit is reached. To this end, the driver assistance system can first of all detect a free gap for the vehicle in the target lane and can subsequently adapt the speed of the vehicle for the following lane change into the detected gap. The lane change itself can be carried out by means of a lane change assistance system, the lane change assistance system being triggered automatically or after an operating input by way of the user.

In the case of a high volume of traffic and therefore a possible lack of gaps in the adjacent lane, driver assistance systems of this type can reach their limits.

It is an object of the present invention to indicate a solution as to how operation of a driver assistance system of the type mentioned at the outset can be improved. Moreover, a vehicle with a corresponding driver assistance system is to be provided.

According to the invention, this object is achieved by way of a method, by way of a driver assistance system and by way of a vehicle with the features according to the independent claims. Advantageous developments of the present invention are specified in the dependent claims.

A method according to the invention serves to maneuver a vehicle on a multi-lane road. The method comprises receiving a driving command for maneuvering the vehicle from a first traffic lane of the road via a second traffic lane of the road to an exit of the road. Moreover, the method comprises preparing a lane change maneuver from the first traffic lane to the second traffic lane, a speed of the vehicle being adapted for the preparation of the lane change maneuver. Furthermore, the method comprises determining a gradient of the road in a region of the exit, and adapting the preparing or preparation of the lane change maneuver in a manner which is dependent on the determined gradient.

With the aid of the method, a driver or user of the vehicle is to be assisted during maneuvering of the vehicle on the multi-lane road. The road can fundamentally be a highway, a main road, an expressway, a freeway-like road or the like. The road is preferably a freeway, however. The road can have, for example, two carriageways with in each case at least two traffic lanes. This vehicle and also further road users can move in a predefined driving direction in these traffic lanes. The road can have at least the first traffic lane and the second traffic lane. Here, the second traffic lane can adjoin the exit or a deceleration lane which leads to the exit. The second traffic lane can be, for example, the right-hand lane of a freeway.

The driving command is received by means of the driver assistance system, which driving command describes that the vehicle is to be maneuvered, starting from the first traffic lane, via the second traffic lane to the exit of the road. In other words, first of all a lane change from the first traffic lane to the second traffic lane is therefore to be carried out, and the vehicle is subsequently to leave the road via the exit. Here, the driving command can be predefined by way of a routing means or a navigation system of the vehicle. As an alternative or in addition, the driving command can also be given by way of a corresponding operating input by the driver.

With the aid of the driver assistance system, the lane change from the first traffic lane to the second traffic lane can be prepared. To this end, a search for free gaps for the vehicle in the second traffic lane can first of all be carried out by way of corresponding proximity sensors or environmental sensors of the driver assistance system. In addition, the speed of the vehicle can be adapted and/or an intervention in the longitudinal control can be carried out by means of the driver assistance system. In particular, the speed of the vehicle can be decreased and/or adapted to the speed of the further road users in the target lane or the second traffic lane. The speed of the vehicle can be adapted in such a way that a gap in the target lane is pursued. Subsequently, the at least partially automated lane change maneuver can then be carried out by means of a lane change assistant. Depending on the country-specific requirement, the lane change assistant can be initiated automatically by way of the driver assistance system or as a consequence of an operating input by way of the user. In the second case, the notice “Trigger lane change, in order to follow route” can be output to the user, for example, when level with the gap.

A corresponding strategy can therefore fundamentally be predefined for initiating the automated lane change maneuver. This strategy can predefine, for example, from which time or from which distance from the exit the gap search is started. In addition, the strategy can describe from which time or from which distance from the exit the speed is adapted. In addition, the strategy can describe the output of the notices to the driver.

It is then provided according to the present invention that the gradient of the road in the region of the exit is determined. This means that the gradient of the road in the immediate or direct surrounding area of the exit is determined. As an alternative or in addition, it can also be provided that the gradient is determined in a defined route section before the exit. Moreover, it is provided that the strategy for initiating the automated lane change maneuver is adapted in a manner which is dependent on the determined gradient.

The gradient in the region of the exit can be determined on the basis of digital map data. These digital map data can describe the gradient in the region of the exit and/or in a region before the exit. As an alternative or in addition, the data from at least one environmental sensor of the vehicle can be used, in order for it to be possible for the gradient in the region of the exit to be determined.

It is taken into account in the present invention that, in the case of comparatively great gradients, the other road users or vehicles in the second traffic lane are often moving at a low speed. In addition, it has been observed that these vehicles which are situated in the second traffic lane have small gaps or are at small distances from one another. In order to counteract this high volume of traffic and the resulting challenges during the lane change maneuver from the first traffic lane to the second traffic lane, the strategy for the preparation of the lane change maneuver is adapted to the gradient in the present case. Therefore, for example, the automated lane change maneuver can be initiated earlier in comparison with roads with a very small gradient in the region of the exit. The adaptation of the preparation of the lane change maneuver can comprise as an alternative or in addition that a speed profile is adapted. For example, when the vehicle approaches the exit, the speed profile can be adapted downward. Overall, this can therefore be carried out more reliably in comparison with known driver assistance systems, in the case of which low speeds of road users in the second traffic lane are taken into consideration before the exit only if they are detected by way of the environmental sensor system.

A traffic density and/or a presence of trucks in the second traffic lane is preferably determined, and the preparation of the lane change maneuver is adapted in a manner which is dependent on the traffic density and/or the presence of the trucks. On the basis of data of the environmental sensors of the driver assistance system and/or using traffic data, a traffic density on the road or in the right-hand traffic lane of the road can be determined. In particular, the traffic density in the region of the exit or in a region before the exit can be determined. As an alternative or in addition, a presence of trucks can be determined on the basis of the data of the environmental sensors. Furthermore, it can be provided that the presence of trucks is estimated using the current day of the week and/or the current time. Here, for example, a driving ban for trucks on certain days of the week can be taken into consideration. Moreover, it can be taken into consideration that the presence of trucks varies in a manner which is dependent on the time or time of day. The strategy for the initiation of the automated lane change maneuver can then additionally be adapted using the traffic density and/or the presence of the trucks. This means, in particular, that the automated lane change maneuver is initiated earlier, the higher the traffic density or the more trucks in the second traffic lane.

In a further embodiment, in the case of the preparation of the lane change maneuver, the speed of the vehicle is reduced to a target speed, the target speed and/or a distance from the exit, from which the target speed is reached, being adapted in a manner which is dependent on the determined gradient. In addition, it can be provided that the target speed and/or a distance from the exit, from which the target speed is reached, are/is adapted in a manner which is dependent on the traffic density and/or the presence of the trucks. As described at the outset, the speed or longitudinal speed of the vehicle can be reduced or adapted to the further road users in the second traffic lane in order to initiate or to prepare for the automated lane change maneuver. In addition, a speed profile and/or a speed curve which is then adapted on the basis of the gradient can be predetermined for the movement of the vehicle. If a high volume of traffic is then to be expected, for example, on the basis of the detected gradient in the region of the exit, the distance, from which the target speed is to be reached, can be increased. The target speed can fundamentally be determined in such a way that a difference between the target speed and the speed of the further road users in the second traffic lane is not too great or does not exceed a predefined threshold value. Traffic safety can be ensured in this way.

The distance, from which the longitudinal speed of the vehicle is reduced, can fundamentally be determined in a speed-dependent manner. In particular, the distance can be increased as the gradient increases. In the same way, the value of the target speed itself can be adapted to the gradient. For example, the target speed can be reduced as the gradient increases, since it is to be assumed that the further road users, in particular trucks, in the second traffic lane are being moved at a comparatively low speed. The operation of the driver assistance system can be improved by way of the timely adaptation of the target speed.

Furthermore, it is advantageous if the speed is reduced in a plurality of steps, and the steps are adapted in a manner which is dependent on the determined gradient. In addition, these steps can be adapted in a manner which is dependent on the volume of traffic and/or the presence of trucks. It can therefore also be provided that the driver assistance system reduces the longitudinal speed of the vehicle in a plurality of steps, in order to initiate or prepare for the automated lane change. This applies, in particular, to the case where at least one further lane change maneuver is also carried out before the lane change from the first traffic lane to the second traffic lane. Different target speeds can be defined here for the respective steps. Here, as described above, these target speeds can be adapted to the determined gradient. Moreover, the number of steps, in which the speed is reduced, can also be adapted to the determined gradient. For example, the number of steps can be increased as the gradient increases. An abrupt reduction of the longitudinal speed by the vehicle in question can be prevented by way of the stepped reduction of the speed, and therefore the safety in road traffic can be ensured.

Furthermore, it is advantageous if, in the case of the initiation of the lane change maneuver, a gap is sought between further road users in the second traffic lane, and a distance from the exit, from which distance the search is started, is adapted in a manner which is dependent on the determined gradient. Furthermore, the distance from the exit, from which the search is started, can be adapted in a manner which is dependent on the volume of traffic and/or the presence of trucks. In other words, the start time for the gap search can therefore be adapted to the gradient in the region of the exit. It can fundamentally be assumed here that the gap search is started earlier, the greater the gradient and/or the higher the volume of traffic in the region of the exit or before the exit. It can be guaranteed in this way, for example, that the lane change from the first traffic lane to the second traffic lane is carried out successfully and therefore the vehicle can leave the multi-lane road via the exit.

In a further embodiment, in the case of the preparation of the lane change maneuver, at least one notice is output to a user of the vehicle, the outputting of the at least one notice being adapted in a manner which is dependent on the determined gradient. In addition, it can be provided that the at least one notice is adapted in a manner which is dependent on the traffic density and/or the presence of trucks. Depending on the configuration of the driver assistance system and/or depending on the country-specific requirement, a corresponding notice can be output to the user or driver. For example, the user can be asked to trigger or to initiate the automated lane change maneuver. It can also fundamentally be provided that the notice describes that the lane change maneuver is carried out in an automated manner by the driver assistance system, or that the driver is to carry out the lane change maneuver manually. These notices can fundamentally be output visually, acoustically and/or haptically to the user or driver. Here, corresponding escalation stages can also be provided, by way of which notices are output to the driver. For example, a visual notice can first of all be provided, and an acoustic notice can additionally be output in a further escalation stage. These escalation stages can therefore be increased earlier in a manner which is dependent on the determined gradient, in order to make automated lane change maneuvers of this type possible. In addition, it can be provided that, as an additional escalation stage, the driver is asked to maneuver the vehicle manually into the exit, if it is foreseeable that the vehicle can no longer be maneuvered into the exit by means of the driver assistance system.

In addition, the distance from the exit, from which the lane change maneuver is carried out, can be adapted in a manner which is dependent on the determined gradient. If the lane change maneuver is carried out in an at least partially automated manner, it can be carried out earlier as a gradient increases and/or as a volume of traffic increases. The greater therefore the gradient in the region of the exit and/or the higher the volume of traffic in the region of the exit, the greater the distance from the exit, from which the lane change maneuver is carried out.

In a further refinement, the preparation of the lane change maneuver is adapted in a manner which is dependent on a known driving behavior of the driver or the user of the vehicle. Here, the driving behavior of the user can describe, for example, whether the driver or user acts in a more sporty or more comfortable or restrained manner during manual driving of the vehicle. This known driving behavior can be detected in a known way during the manual operation of the vehicle. Here, the strategy for the initiation of the automated lane change maneuver can then be adapted additionally to the driving behavior of the user. In the case of a more sporty driver, for example, the adaptation of the speed can therefore take place at a later time, or a higher value can be selected for the speed or the target speed. In the case of a sporty driver, the lane change can also be carried out at a later time. In this way, the vehicle can still be moved at a relatively high speed in the first traffic lane. In comparison with this, in the case of a cautious driver, the initiation of the automated lane change maneuver can fundamentally be carried out earlier. Here, for example, the vehicle can then also be maneuvered with a comparatively low speed in the second traffic lane up to the exit. In this way, the operation of the driver assistance system can be adapted to the driving behavior of the user. Here, the driver assistance system can also use different settings for different users.

In addition, it can be provided that at least one further lane change is prepared and subsequently carried out before the lane change from the first traffic lane to the second traffic lane. The strategy for the preparation and/or carrying out of this at least one further lane change can also be adapted in a manner which is dependent on the gradient and/or the volume of traffic in the region of the exit.

A further aspect of the invention relates to a method for maneuvering a vehicle on a multi-lane road. The method comprises receiving a driving command for maneuvering the vehicle from a first traffic lane of the road via a second traffic lane of the road to an exit of the road. Moreover, the method comprises preparing a lane change maneuver from the first traffic lane to the second traffic lane, a speed of the vehicle being determined for the preparation of the lane change maneuver. Furthermore, the method comprises determining a volume of traffic and/or a presence of trucks in a region of the exit, and adapting the provision of the lane change maneuver in a manner which is dependent on the determined volume of traffic and/or the presence of the trucks.

A driver assistance system according to the invention for a vehicle is configured to carry out a method according to the invention and the advantageous refinements thereof. The driver assistance system can have at least one environmental sensor, by way of which the further road users in the surrounding area of the vehicle and, in particular, in the adjacent traffic lanes can be detected. Moreover, the driver assistance system or a corresponding computing device of the driver assistance system can determine the gradient in the region of the exit on the basis of the data of the at least one environmental sensor. In addition, the driver assistance system can have a corresponding communications device, via which corresponding map data and/or traffic data can be received. These traffic data can describe, in particular, the traffic flow and/or the current volume of traffic. The map data and/or the traffic data can be received by a backend means or the like. The gradient in the region of the exit can also be determined on the basis of these map data and/or traffic data. The computer device can be formed by way of at least one electronic control unit. The computer device can fundamentally have at least one processor and a memory. Digital maps can also be stored in this memory. By means of the computing device, the strategy for the initiation of the automated driving maneuver can then also be adapted.

In addition, a trajectory for maneuvering the vehicle or for the automated lane change maneuver can be calculated by means of the computing device. Moreover, the computing device can be configured to output a control signal for actuating a steering means or a steering system of the vehicle. The lateral control of the vehicle can be taken over during the lane change maneuver by way of the actuation of the steering means. It can also be provided that the longitudinal control of the vehicle is taken over by means of the driver assistance system during the lane change maneuver or during the preparation of the lane change maneuver.

A vehicle according to the invention comprises a driver assistance system according to the invention. The vehicle is configured, in particular, as a passenger motor car.

The preferred embodiments proposed in relation to the method according to the invention and their advantages apply mutatis mutandis to the driver assistance system according to the invention and to the vehicle according to the invention.

Further features of the invention result from the claims, the figures and the description of the figures. The features and combinations of features mentioned above in the description and the features and combinations of features mentioned below in the description of the figures and/or shown only in the figures can be used not only in the respective specified combination, but rather also in different combinations or on their own, without departing from the scope of the invention.

The invention will now be explained in greater detail on the basis of preferred exemplary embodiments and with reference to the appended drawings.

### BRIEF DESCRIPTION OF THE DRAWINGS

FIG. 1 is a diagrammatic illustration of a vehicle which has a driver assistance system for carrying out an automated lane change maneuver; and

FIG. 2 illustrates the vehicle according to FIG. 1 in a traffic situation, the vehicle being situated on a multi-lane road, and a maneuver being planned starting from a first traffic lane of the road to an exit of the road.

Identical or functionally identical elements are provided with the same designation in the figures.

### DETAILED DESCRIPTION OF THE DRAWINGS

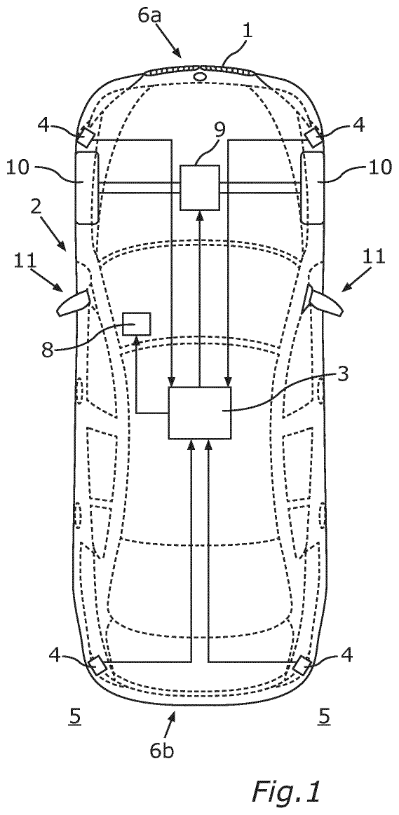

FIG. 1 shows a plan view of a vehicle 1 which is configured in the present case as a passenger motor car. The vehicle 1 comprises a driver assistance system 2, by means of which the driver can be assisted when maneuvering on a multi-lane road 11. The vehicle 2 comprises a computing device 3 which can comprise, for example, at least one electronic control unit. In particular, the computing device 3 can have at least one processor and a memory.

Moreover, the driver assistance system 2 comprises at least one environmental sensor 4. In the present example, the driver assistance system 2 comprises four environmental sensors 4, of which two environmental sensors 4 are arranged in a front region 6a and two environmental sensors 4 are arranged in a rear region 6b of the vehicle 1. Here, the environmental sensors 4 or distance sensors are arranged at the respective corners of the vehicle 1. The environmental sensors 4 can be configured, for example, as radar sensors. Corresponding measurements can be carried out by way of the environmental sensors 4, in order for it to be possible for objects and, in particular, further road users 7 in a surrounding area 5 of the vehicle 1 to be detected.

Moreover, the computing device 3 is configured to actuate a steering system 9 (shown merely diagrammatically in the present case) of the vehicle 1. Lateral control of the vehicle 1 can be taken over during an automated lane change maneuver by way of the actuation of the steering system 9. The steerable wheels 10 of the vehicle 1 can be steered and therefore the lateral control can be taken over during the lane change maneuver by way of the actuation of the steering system 9. In addition, it is provided that a drive motor and/or brake system of the vehicle 1 are/is actuated by means of the computing device 3, in order to take over the longitudinal control of the vehicle 1. In this way, the lane change maneuvers can be prepared for. Moreover, the driver assistance system 2 comprises an output device 8, by means of which a notice can be output to the driver or user of the vehicle 1.

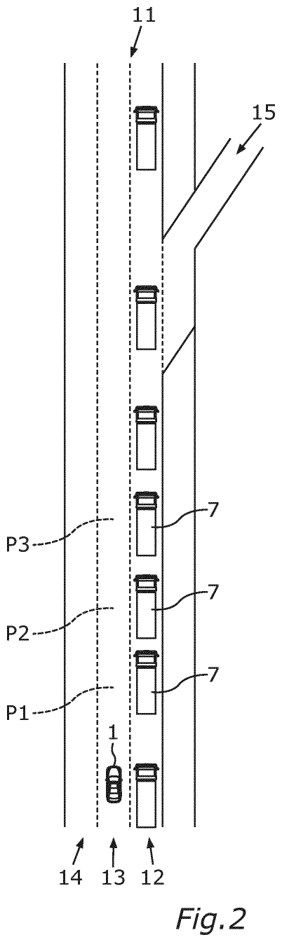

FIG. 2 shows a diagrammatic illustration of a traffic situation, in the case of which the vehicle 1 according to FIG. 1 is situated on a multi-lane road 11. In the present example, the road 11 is configured as a freeway. In the present case, the road 11 comprises a first traffic lane 13 or a middle lane, a second traffic lane 12 or a right-hand lane, and a third traffic lane 14 or a left-hand lane. In the present case, the vehicle 1 is situated in the first traffic lane 13 or the middle lane. It is provided here in the present case that the vehicle 1 is to be maneuvered from the first traffic lane 13 via the second traffic lane 12 to an exit 15 of the road 11. In this way, the vehicle 1 can follow, for example, a predefined navigation route.

In addition, it is provided that an automatic lane change maneuver is carried out from the first traffic lane 13 to the second traffic lane 12. The initiation or the preparation of this lane change maneuver is carried out on the basis of a predefined strategy. It can be stored in this strategy, for example, at which time or from which distance from the exit 15 a longitudinal speed of the vehicle 1 is adapted for the lane change. In addition, it can be defined, from which distance from the exit 15 a gap search between further road users 7 in the second traffic lane is started.

In addition, it is provided in the present case that a gradient of the road 11 in a region of the exit 15 is determined. In order for it to be possible for the gradient to be determined, data from the environmental sensors 4 can be used. Moreover, the digital map data can be taken into consideration. In addition, it is provided that a traffic density and/or a presence of trucks in the second traffic lane 12 are/is determined. In the present example, a plurality of road users 7 in the form of trucks are situated in the second traffic lane 12. It is provided here that the strategy for the initiation of the lane change maneuver is adapted in a manner which is dependent on the gradient in the region of the exit 15 and/or on the basis of the traffic density and/or the number of trucks in the second traffic lane 12.

In the present case, it is assumed that the road 11 in the region of the exit 15 has a predefined gradient. In the example, the vehicle 1 is situated in the first traffic lane 13 or the middle lane. Trucks are already detected approximately every 200 m, 1.5 km before the exit 15. It is provided here that the longitudinal speed of the vehicle 1 is already reduced to 100 km/h by means of the driver assistance system 2 from a first point P1 which can be, for example, at a distance of 1 km from the exit 15. In the further course, the speed of the vehicle 1 can be reduced to 80 km/h. From a point P2 which can be, for example, at a distance of 800 m from the exit 15, the search for free gaps between the further road users 7 in the second traffic lane 12 can be started. In addition, the notices which are output to the user or the escalation stage can be increased successively. From a third point P3 which can be, for example, at a distance of 600 m from the exit, the speed of the vehicle 1 can then be reduced further to 60 km/h, and the lane change can be carried out behind one of the trucks in the second traffic lane 12. Subsequently, the vehicle can be moved via the exit 15 from the road 11.

Therefore, the operation of the driver assistance system 2, in particular the strategy for the preparation of the automated lane change maneuver, can overall be adapted to the gradient in the region of the exit 15 and/or the traffic density and/or the presence of trucks in the second traffic lane 12 or the right-hand lane of the road 11.

1.-9. (canceled)

10. A method for maneuvering a vehicle on a multi-lane road, the method comprising the steps of:
receiving a driving command for maneuvering the vehicle from a first traffic lane of the road via a second traffic lane of the road to an exit of the road;
preparing a lane change maneuver from the first traffic lane to the second traffic lane, a speed of the vehicle being adapted for the preparation of the lane change maneuver;
determining a gradient of the road in a region of the exit; and
adapting the preparation of the lane change maneuver in a manner which is dependent on the determined gradient.

11. The method according to claim 10, wherein
a traffic density and/or a presence of trucks in the second traffic lane is determined, and
the preparation of the lane change maneuver is adapted in a manner which is dependent on the traffic density and/or the presence of the trucks.

12. The method according to claim 10, wherein
in the case of the preparation of the lane change maneuver, the speed of the vehicle is reduced to a target speed, and
the target speed and/or a distance from the exit, from which the target speed is reached, is adapted in a manner which is dependent on the determined gradient.

13. The method according to claim 12, wherein
the speed of the vehicle is reduced in a plurality of steps, and
the plurality of steps are adapted in a manner which is dependent on the determined gradient.

14. The method according to claim 10, wherein
in the case of the preparation of the lane change maneuver, a gap is sought between further road users in the second traffic lane, and
a distance from the exit, from which distance the gap search is started, is adapted in a manner which is dependent on the determined gradient.

15. The method according to claim 10, wherein
in the case of the preparation of the lane change maneuver, at least one notice is output to a user of the vehicle, the outputting of the at least one notice being adapted to the determined gradient.

16. The method according to claim 10, wherein
the preparation of the lane change maneuver is adapted in a manner which is dependent on a known driving behavior of the user of the vehicle.

17. A system for a vehicle, comprising:
a computer-implemented driver assistance system configured to:
receive a driving command for maneuvering the vehicle from a first traffic lane of the road via a second traffic lane of the road to an exit of the road;
prepare a lane change maneuver from the first traffic lane to the second traffic lane, a speed of the vehicle being adapted for the preparation of the lane change maneuver;
determine a gradient of the road in a region of the exit; and
adapt the preparation of the lane change maneuver in a manner which is dependent on the determined gradient.

18. A vehicle comprising a system according to claim 17.

19. The vehicle according to claim 18, wherein the vehicle is a passenger motor car.
